(19) United States
(12) Patent Application Publication
(10) Pub. No.: US 2025/0350765 A1
(43) Pub. Date: Nov. 13, 2025

(54) GENERALIZABLE LEARNED TRIPLANE COMPRESSION

(71) Applicant: NVIDIA Corporation, Santa Clara, CA (US)

(72) Inventors: Amrita Mazumdar, Asbury Park, NJ (US); Shalini De Mello, San Francisco, CA (US)

(21) Appl. No.: 19/180,743

(22) Filed: Apr. 16, 2025

Related U.S. Application Data
(60) Provisional application No. 63/645,673, filed on May 10, 2024.

(51) Int. Cl. H04N 19/597; H04N 7/15

(52) U.S. Cl. CPC H04N 19/597; H04N 7/15

(57) ABSTRACT

Triplanes are data representations used in computer graphics to encode scenes into compact feature representations that balance expressiveness with efficiency. Despite their efficiency, triplanes still suffer from large data bandwidth size, precluding use in streaming or dynamic settings. Methods which aim to compress triplanes, however, must be trained alongside the model and as a result are not generalizable among different scenes. The present disclosure provides a generalizable solution for triplane compression that can be applied to various triplanes without scene-specific training or finetuning.

### CLAIM OF PRIORITY

This application claims the benefit of U.S. Provisional Application No. 63/645,673 (Attorney Docket No. NVIDP1402+/24-SC-0566US01) titled “GENERALIZABLE LEARNED TRIPLANE COMPRESSION,” filed May 10, 2024, the entire contents of which is incorporated herein by reference.

### TECHNICAL FIELD

The present disclosure relates to compression for computer graphics.

### BACKGROUND

Data compression is an important tool in computer graphics which allows storage, bandwidth, and memory demands to be reduced. As graphics technology continues to advance to provide greater detail and to support more applications, the importance of available compression methods only increases.

For example, neural radiance fields (NeRFs) are a powerful representation for three-dimensional (3D) visual media, with applications in augmented reality/virtual reality (AR/VR), 3D rendering, and immersive telepresence. Triplane NeRF representations encode large scenes into a compact feature representation that balances expressiveness with efficiency. Many recent works leverage the flexibility of triplanes or related feature plane representations to capture a diversity of 3D assets, ranging across faces, objects, avatars, room geometry, and dynamic scenes.

Despite their efficiency, triplanes still suffer from large data bandwidth size, precluding use in streaming or dynamic settings. To address this, recent works investigate NeRF compression, which either learns a compressed representation of a NeRF or a scene-specific codec that is learned alongside the NeRF model. These techniques can compress triplanes in the hundreds of megabytes by up to hundreds of kilobytes, but the compression method must be trained alongside the model. By contrast, traditional image and video compression methods are generalizable: they are tuned for a diverse distribution of input content and can be applied to unseen data. Moreover, generalizable compression methods do not require any scene-specific training.

There is thus a need for addressing these issues and/or other issues associated with the prior art. For example, there is a need for a generalizable solution for triplane compression that can be applied to various triplanes without scene-specific training or finetuning.

### SUMMARY

A method, computer readable medium, and system are disclosed to compress a triplane representation of data. A triplane representation of data is compressed to form a compressed representation of the data, using a codebook that stores a plurality of triplane features with corresponding codes. The compressed representation of the data is output.

### BRIEF DESCRIPTION OF THE DRAWINGS

FIG. 1 illustrates a flowchart of a method for compressing a triplane representation of data, in accordance with an embodiment.

FIG. 2 illustrates an exemplary triplane representation of data, in accordance with an embodiment.

FIG. 3 illustrates a system architecture providing a generalized method to compress triplane representations of data, in accordance with an embodiment.

FIG. 4 illustrates a training flow for the system architecture of FIG. 3, in accordance with an embodiment.

FIG. 5 illustrates an inference flow for the system architecture of FIG. 3, in accordance with an embodiment.

FIG. 6 illustrates an exemplary implementation of the system architecture of FIG. 3, in accordance with an embodiment.

FIG. 7 illustrates a method for processing a compressed triplane representation of data, in accordance with an embodiment.

FIG. 8A illustrates inference and/or training logic, according to at least one embodiment;

FIG. 8B illustrates inference and/or training logic, according to at least one embodiment;

FIG. 9 illustrates training and deployment of a neural network, according to at least one embodiment;

FIG. 10 illustrates an example data center system, according to at least one embodiment.

### DETAILED DESCRIPTION

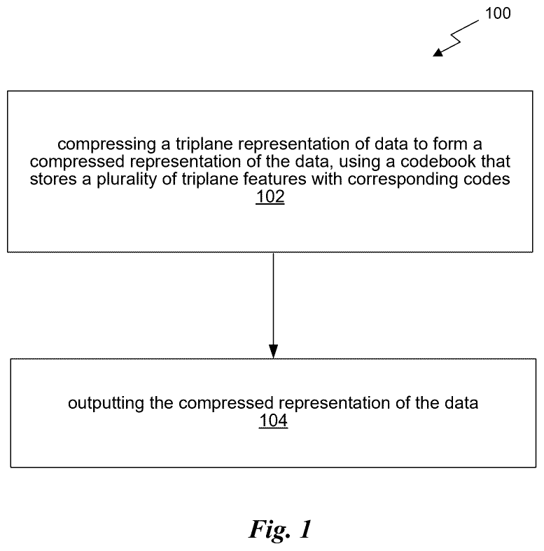

FIG. 1 illustrates a flowchart of a method 100 for compressing a triplane representation of data, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, a triplane representation of data is compressed to form a compressed representation of the data, using a codebook that stores a plurality of triplane features with corresponding codes. With respect to the present description, the data refers to any data capable of being represented as a triplane. In an embodiment, the data may be a two-dimensional (2D) image. In an embodiment, the 2D image may be captured by a camera. Just by way of example, the 2D image may be an image of a face of a person captured by the camera, which may be located on a device of the person (e.g. a laptop, mobile phone, etc.).

The triplane refers to a data representation in which the data is represented in three orthogonal planes (e.g. xy, xz, and yz). In an embodiment, the data representation may be a three-dimensional (3D) representation. For example, the three orthogonal planes may define a 3D space. In an embodiment, the data may be represented using three 2D feature grids aligned with the three orthogonal planes.

In an embodiment, the method 100 may include receiving the triplane representation of the data as input. For example, a remote process or system may generate the triplane representation of the data and provide the triplane representation of the data to the process or computer system for performing the method 100. In another embodiment, the method 100 may include generating the triplane representation of the data. In an embodiment, the triplane representation of the data may be generated using a generative triplane model (e.g. configured to generate triplane representations from a given 2D or 3D data).

As mentioned above, the triplane representation of the data is compressed, using a (i.e. at least one) codebook that stores a plurality of triplane features with corresponding codes, to form a compressed representation of the data. In an embodiment, the compressed representation of the data may be of a smaller size (memory-wise) than the triplane representation of the data. In an embodiment, the codebook may be a model of triplane features learned via machine learning. Embodiments of learning the codebook will be described in more detail below. In an embodiment, the corresponding codes may be indices in the codebook or other unique identifiers of the triplane features.

In an embodiment, the codebook may be selected from among a plurality of codebooks for compressing the triplane representation of the data. In an embodiment, the plurality of codebooks may correspond to different compression ratios, and the selected codebook may correspond to a compression ratio predetermined to be used for compressing the triplane representation of the data. For example, the compression ratio may be predetermined based on a current bandwidth available for transmitting the compressed representation of the data.

In an embodiment, compressing the triplane representation of the data to form the compressed representation of the data, using the codebook may include processing the triplane representation of the data, by an encoder, to infer a subset of codes in the codebook that correspond to triplane features representing the triplane representation of the data, and outputting the subset of codes as the compressed representation of the data.

Returning to the learning of the codebook, in an embodiment, the codebook may be learned over a plurality of training iterations using a set of training data. This may include, for each of the training iterations, selecting an instance of data from the set of training data, generating a triplane representation of the instance of data, compressing the triplane representation of the instance of data to form a compressed representation of the instance of data, using a current instance of the codebook, decompressing the compressed representation of the instance of data to form a reconstructed triplane representation of the instance of data, using the current instance of the codebook, computing at least one loss using the reconstructed triplane representation of the instance of data, and optimizing the current instance of the codebook based on the at least one loss to form a new current instance of the codebook.

In an embodiment, the loss may include a reconstruction loss computed between the triplane representation of the instance of data and the reconstructed triplane representation of the instance of data, where the current instance of the codebook may be optimized to minimize the reconstruction loss. In an embodiment, the loss may include a perceptual loss computed between the instance of data selected from the set of training data and a reconstructed version of the instance of data generated from the reconstructed triplane representation of the instance of data, where the current instance of the codebook may be optimized to minimize the perceptual loss. In another embodiment where the instance of data is an image of a face, the loss may include an identity loss computed between identity features generated from the instance of data and reconstructed identity features generated from a reconstructed version of the instance of data which has been generated from the reconstructed triplane representation of the instance of data, where the current instance of the codebook may be optimized to minimize the identity loss. In still yet another embodiment where the selected instance of data is an instance of multi-view data, the loss may include an adversarial loss between the triplane representation of the multi-view instance of data and the reconstructed triplane representation of the multi-view instance of data and between the instance of multi-view data and a reconstructed version of the multi-view instance of data generated from the reconstructed triplane representation of the multi-view instance of data, where the current instance of the codebook may be optimized to minimize the adversarial loss.

In operation 104, the compressed representation of the data is output. In an embodiment, outputting the compressed representation of the data may include storing the compressed representation of the data in a memory. For example, the compressed representation of the data may be stored for later access by a local or remote process/system that executes a downstream task. In another embodiment, outputting the compressed representation of the data may include providing the compressed representation of the data to a downstream task. In an embodiment, the downstream task may use the compressed representation of the data to train a 3D generative model.

In an embodiment, outputting the compressed representation of the data may include transmitting the compressed representation of the data over a network to a target device. In an embodiment, the target device may include a decoder for decompressing the compressed representation of the data into a reconstructed triplane representation of the data, where the target device is configured to render the data from the reconstructed triplane representation. In various exemplary embodiments, the data may be rendered for use with a video conferencing application, for use with an application depicting static 3D scenes, for use with an application depicting 3D scenes in video, etc. In an embodiment, the target device may be configured to render a novel view from the reconstructed triplane representation.

Further embodiments will now be provided in the description of the subsequent figures. It should be noted that the embodiments disclosed herein with reference to the method 100 of FIG. 1 may apply to and/or be used in combination with any of the embodiments of the remaining figures below.

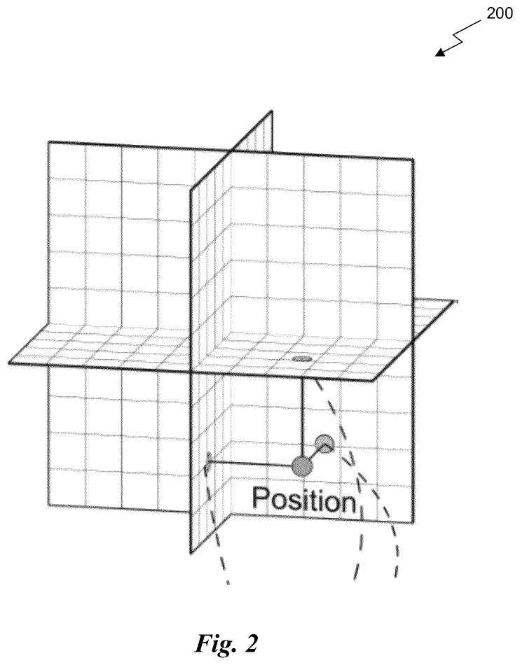

FIG. 2 illustrates an exemplary triplane representation 200 of data, in accordance with an embodiment.

Generally, triplanes may represent a hybrid neural radiance field (NeRF) representation balancing compact storage size and expressiveness of features. In the triplane formulation, explicit features are organized into three axis-aligned orthogonal feature planes, T_{xy}, T_{xz}, T_{yz}∈ [symbol] ^{N×N×C}, where N is spatial resolution and C the number of channels. Given a triplane T, a lightweight multi-layer perceptron (MLP) can render the feature, color, and volume density ((f, c, σ)) of a given point x by projecting the point onto each of the three feature planes, per Equation 1.

$$( f , c , σ ) = MLP ( Φ ( {f}_{xy} , {f}_{xz} , {f}_{yz} ) ) ( f \qquad Equation 1$$

where fᵢⱼ are the features gathered by projecting x to the ij plane and bilinearly interpolating the nearby features, and Φ is the mean operator. By accumulating many points along rays, and performing volume rendering as in NeRF, one can render a red, green, blue (RGB) image I∈ [symbol] ^{3×H×W} from a given camera pose, where H and W are height and width, respectively.

In the embodiments described herein, large triplane datasets produced by synthetic triplane generators or 2D-to-3D triplane encoders may be utilized. Triplane generators learn a latent space for a distribution of triplanes. To generate new triplanes from a pretrained generative adversarial network (GAN), a latent vector is sampled and passed through the triplane GAN to produce a corresponding triplane T. Triplane encoders, on the other hand, learn to lift 2D images to a triplane latent space. Given a single input image Iᵣₑₐₗ, a triplane encoder Eₜᵣᵢ learns T=Eₜᵣᵢ(I).

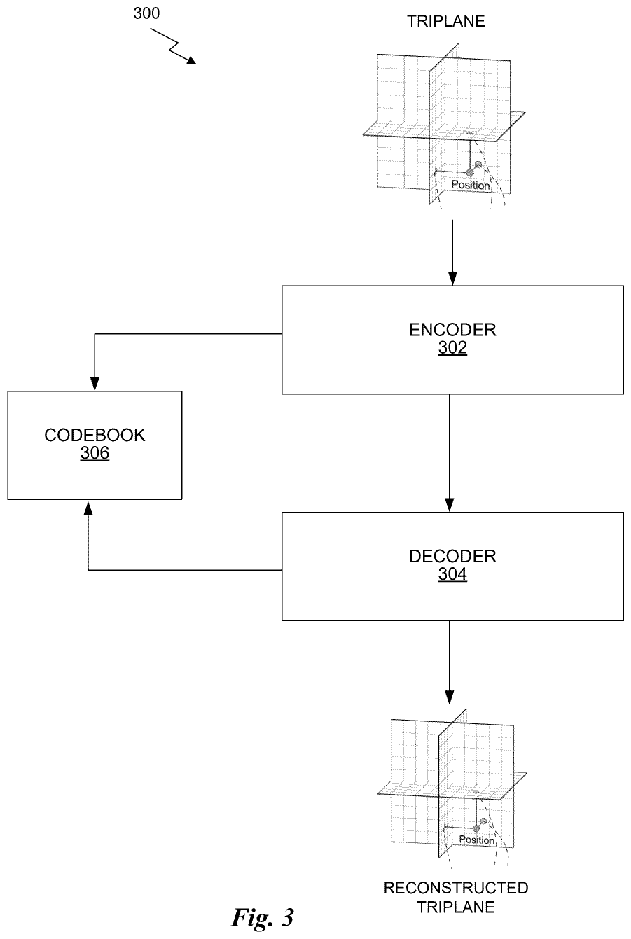

FIG. 3 illustrates a system architecture 300 providing a generalized method to compress triplane representations of data, in accordance with an embodiment. The system architecture 300 may be implemented in the context of any of the prior embodiments described herein. For example, the system architecture 300 may be implemented to carry out the method 100 of FIG. 1.

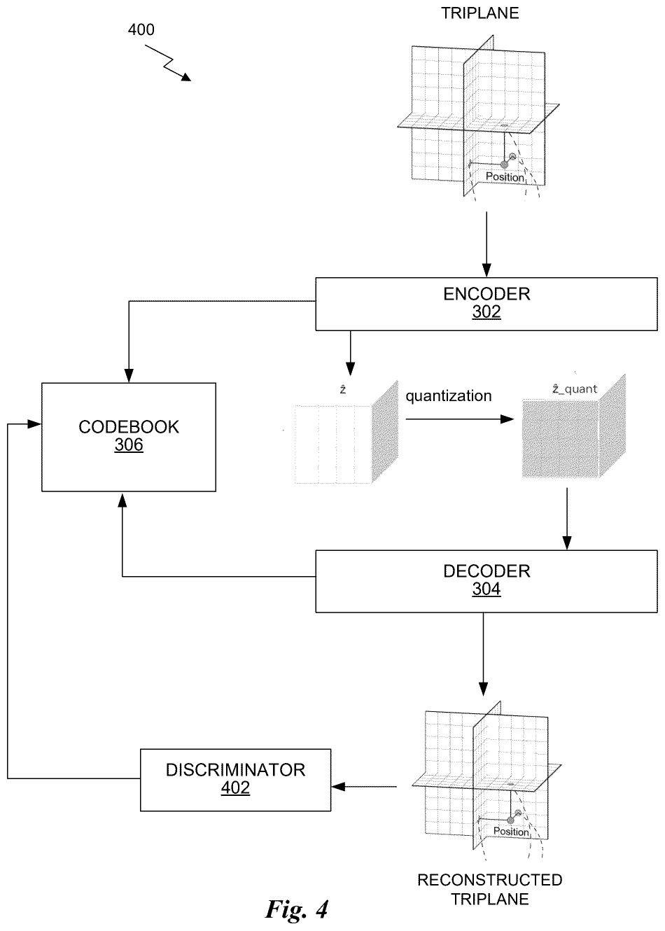

The system architecture 300 includes an encoder (E) 302 that is configured to compress an input triplane representation of data to form a compressed representation of the data. The encoder 302 uses a codebook 306 to compress the input triplane. The codebook 306 specifically stores a plurality of triplane features with corresponding codes. The codebook 306 may be learned per the training flow 400 described below with respect to FIG. 4.

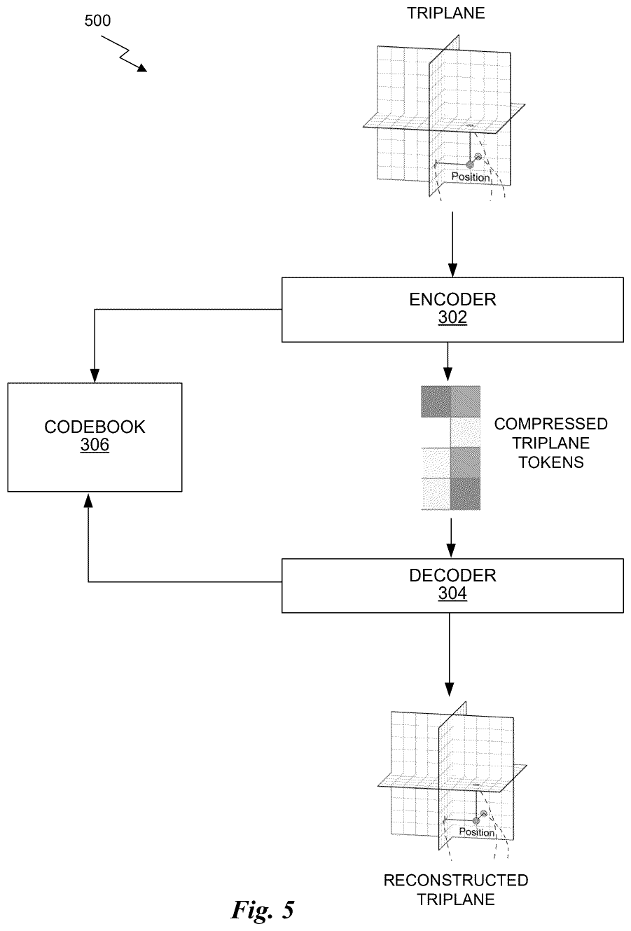

The system architecture 300 includes a decoder (D) 304 that is configured to decompress the compressed representation of the data (generated by the encoder 302) to form a reconstructed triplane. The decoder 304 uses the codebook 306 to decompress the compressed representation of the data. The encoder 302 and decoder 304 may operate per the inference flow 500 described below with respect to FIG. 5.

In embodiments, any combination of the encoder 302, decoder 304 and/or codebook 306 may be deployed to a same or different computer systems. For example, the encoder 302 and codebook 306 may be deployed to a first computer system, while the decoder 304 and optionally another instance of the codebook 306 may be deployed to a second computer system. In an embodiment, the first computer system may be located in the cloud and the second computer system may be a local system executing a downstream application that uses the reconstructed triplane (e.g. for rending images therefrom).

In an embodiment, the system architecture 300 may receive the triplane as an input (e.g. from a remote process or system). In an embodiment, the system architecture 300 may include a generative triplane model (not shown) for generating the triplane from an input. In an embodiment, the system architecture 300 may include a 2D-to-3D triplane encoder (not shown) for generating the triplane from an input 2D image.

In an embodiment, the system architecture 300 may output the reconstructed triplane. In an embodiment, the system architecture 300 may output the reconstructed triplane to a memory or to a remote process or system. In an embodiment, the system architecture 300 may include a renderer (not shown) for rendering an image from the reconstructed triplane.

FIG. 4 illustrates a training flow 400 for the system architecture 300 of FIG. 3, in accordance with an embodiment.

A vector-quantized autoencoder model learns the codebook 306 dictionary of features from a dataset of triplanes. The dataset may be generated from a generative triplane model and/or from a 2D-to-3D triplane encoder. The encoder 302 takes triplanes T∈^{N×N×C} as input, instead of images, and learns a latent codebook 306 of triplane features with corresponding codes, from which the decoder 304 can reconstruct the triplanes.

In particular, as shown, for an input triplane T, the encoder (E) 302 maps the triplane to its latent representation \hat{z}. A vector-quantized representation \hat{z}_quant is then obtained by applying element-wise quantization q(·) of each code onto its closest codebook 306 entry. The decoder (D) 304 maps the quantized representation \hat{z}_quant back to the triplane space. The autoencoder is trained end-to-end by encoding and reconstructing triplanes produced from the triplane data source while minimizing one or more losses via a discriminator 402.

In an embodiment, the autoencoder model seeks to produce perceptually-accurate rendered images from reconstructed triplanes, but it does not require perceptually consistent triplanes. As a result, the traditional perceptual loss on the input data can be replaced with perceptual loss computed on a randomly selected rendered image view from the triplane. Adversarial loss may also be augmented to jointly discriminate on the triplane and the rendered view. The full training objective may consist of losses between the ground truth triplane and reconstructed triplanes, losses on rendered views from the ground truth and reconstructed triplanes, and codebook quantization losses. An optional category loss may also be added to further encourage the training to better correspond to category-specific information in the training data distribution (e.g. identity loss for face triplanes).

Denoting the ground truth triplane as T, the reconstructed triplane as \hat{T}, a rendered image from the ground truth triplane as Iᵣ, and a rendered image from the reconstructed triplane as \hat{T}ᵣ, the loss definitions are as follows.

Reconstruction Losses. Two reconstruction losses may be used: one for the triplane feature space and another for the image rendered from the reconstructed triplane. These L1 losses are denoted as: [symbol] ₜᵣᵢₚ=∥T−\hat{T}∥₁ and [symbol] _{Im}=∥Iᵣ−Îᵣ∥₁.

Perceptual Loss. The perceptual loss on rendered image views may be used: [symbol] ₚₑᵣ=∥ø(Îᵣ)∥₁, where ϕ is a pretrained network such as the Visual Geometry Group (VGG)-16 network.

Adversarial Loss. A PatchGAN local discriminator D1 may be used to improve the quality of fine details. The discriminator 402 may support dual discrimination to improve convergence of the multi-view images rendered from the triplanes. The input layer of D1 accepts N+3 channel input images, where N is the number of channels in T, and the rendered RGB image Iᵣ and the triplane used for rendering T are concatenated, including bilinearly resampling Iᵣ if the triplane and image resolutions differ. Using dual discrimination encourages the reconstructed triplane to both match the input triplane and produces rendered images that match the input triplane's images. The objective of the dual discriminator is defined as: [symbol] _{GAN}= [symbol] _{I,T}[log D₁(Î, \hat{T})+log(1−D₁(I, T)))].

Identity Loss. For face triplanes, an optional identity loss may be used: [symbol] _{cate} with face identity features from a deep face recognition method (e.g. ArcFace). For other triplane datasets, λ_{cate} may be set to 0.

Total objective. In an embodiment, the total training objective may be the combination of the above losses:
[symbol] ₜₒₜₐₗ=λₜᵣᵢₚ [symbol] ₜᵣᵢₚ+λᵢₘ [symbol] ᵢₘ+λₚₑᵣ [symbol] ₚₑᵣ+λ_{cate} [symbol] _{cate}+λ_{disc} [symbol] _{disc}, where the λₜᵣᵢₚ, λᵢₘ, λₚₑᵣ, λ_{code}, λ_{cate}, and λ_{disc}, are scale factors of corresponding loss.

FIG. 5 illustrates an inference flow 500 for the system architecture of FIG. 3, in accordance with an embodiment.

As shown, a triplane representation of data is input to the encoder 302. The encoder 302 compresses the triplane representation of the data, using the codebook 306, to form a compressed representation of the data (shown as “compressed triplane tokens”). The compressed representation of the data is accessed by a decoder 304. The decoder 304 decodes the compressed representation of the data using the codebook 306 to form a reconstructed triplane.

The present method 500 can be performed to reconstruct arbitrary triplanes with the learned codebook 306 such that views rendered from a reconstructed triplane maintain high fidelity. Unlike prior methods that learn a compressed NeRF representation from a 2D image collection, the present method 500 relies on a generalizable codebook 306 learned for a distribution of triplanes and from which a compressed representation an arbitrary triplane can be represented as a sequence of codebook indices.

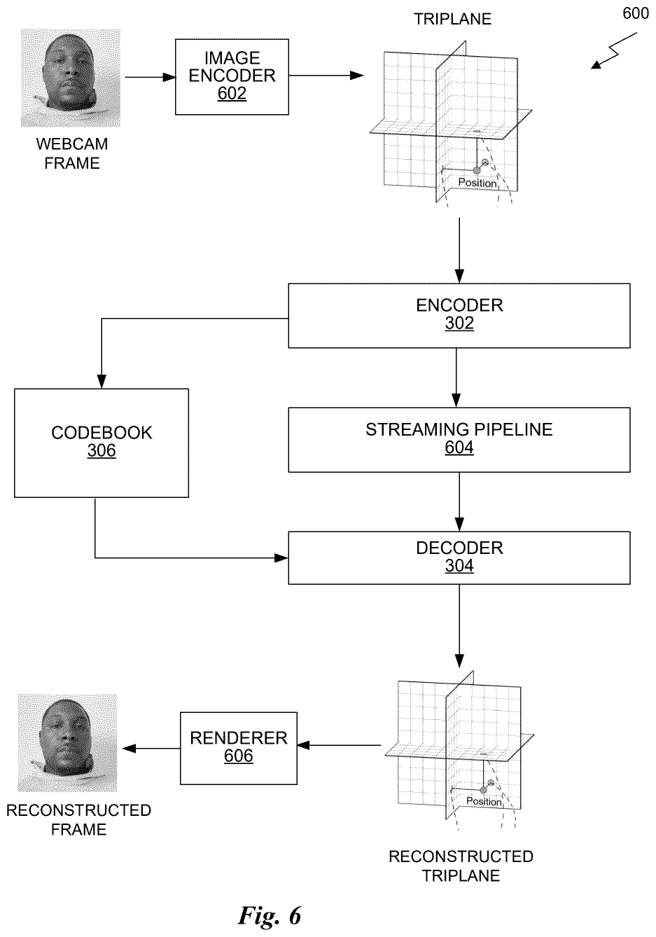

FIG. 6 illustrates an exemplary implementation 600 of the system architecture 300 of FIG. 3, in accordance with an embodiment. The present implementation 600 relates to a video conferencing application in which video frames captured at a first user device are communicated over a network to a second user device for display thereof.

As shown, an image encoder 602 processes an input 2D image (video frame) to generate a triplane representation of the image. The encoder 302 uses the codebook 306 to compress the triplane representation of the image into a compressed representation of the image. The image encoder 602, the encoder 302, and/or the codebook 306 may be located on the first user device or on a remote computer system (e.g. in the cloud).

The compressed representation of the image is transmitted through a streaming pipeline 604 to a decoder 304. The decoder 304 uses the codebook 306 to decompress the compressed representation of the image into a reconstructed triplane representation of the image. A renderer 606 reconstructs the 2D image from the reconstructed triplane. The decoder 304, an instance of the codebook 306 and/or the renderer 606 may be located on the second user device or another computer system local to the second user device.

In one exemplary method of the present implementation 600, a 2D image of a face of a user captured using a first instance of a video conferencing application executing on a first user device may be processed to generate a triplane representation of the face of the user. The triplane representation of the face of the user may be compressed to form a compressed representation of the face of the user, using a codebook 306 that stores a plurality of triplane features with corresponding codes. The compressed representation of the face of the user may be transmitted over a network to a second user device executing a second instance of the video conferencing application. Transmitting the compressed representation of the face of the user to the second user device may cause the second user device to: receive the compressed representation of the face of the user, decompress the compressed representation of the face of the user to generate a reconstructed triplane representation of the face of the user, render from the reconstructed triplane representation at least one view of the face of the user, and display, on a display device of the second user device, the at least one view of the face of the user in an interface of the second instance of the video conferencing application.

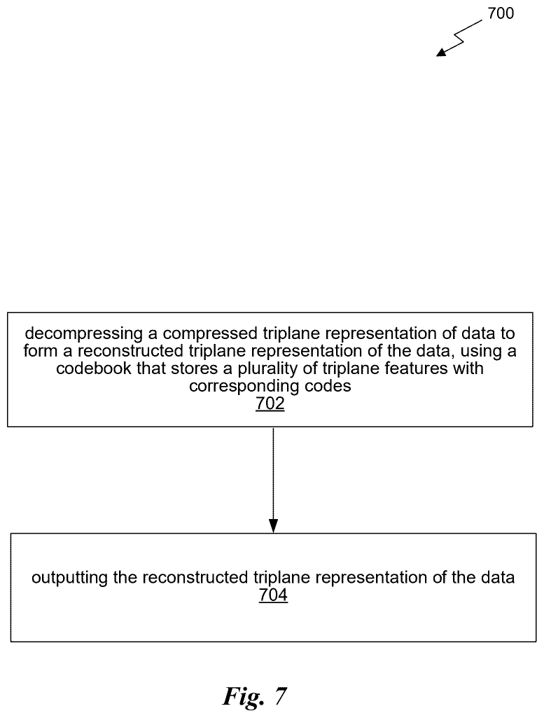

FIG. 7 illustrates a method 700 for processing a compressed triplane representation of data, in accordance with an embodiment.

In operation 702, a compressed triplane representation of data is decompressed to form a reconstructed triplane representation of the data, using a codebook that stores a plurality of triplane features with corresponding codes. The compressed triplane representation of the data may have been generated via the method 100 of FIG. 1, in an embodiment. Operation 702 may be performed using the decoder 304 of FIG. 3, in an embodiment. For example, where the compressed triplane representation of the data is comprised of a subset of codes included in the codebook, triplane features corresponding to those codes can be determined from the codebook and used to reconstruct the triplane representation of the data. In other words, decompressing the compressed triplane representation of the data to form the reconstructed triplane representation of the data, using the codebook may include determining a subset of the codes included in the codebook that comprise the compressed triplane representation of the data, determining, from the codebook, a subset of triplane features corresponding to the subset of the codes, and using the subset of triplane features to reconstruct the triplane representation of the data.

In an embodiment, the codebook may be selected from among a plurality of codebooks for decompressing the triplane representation of the data. In an embodiment, the plurality of codebooks may correspond to different compression ratios, and the selected codebook may correspond to a compression ratio predetermined to have been used to generate the compressed triplane representation of the data.

In operation 704, the reconstructed triplane representation of the data is output. In an embodiment, the reconstructed triplane representation of the data may be output to a memory. In an embodiment, the reconstructed triplane representation of the data may be output to a downstream task. In an embodiment, the reconstructed triplane representation of the data may be output for use (e.g. by the downstream task) in rendering the data from the reconstructed triplane. In an embodiment, the data may be rendered for use with a video conferencing application, for use with an application depicting static 3D scenes, for use with an application depicting 3D scenes in video, for use in rendering novel views, etc.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

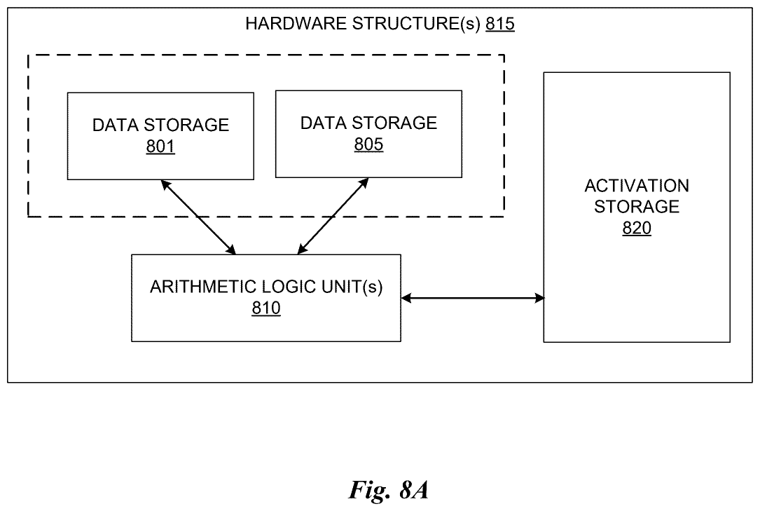

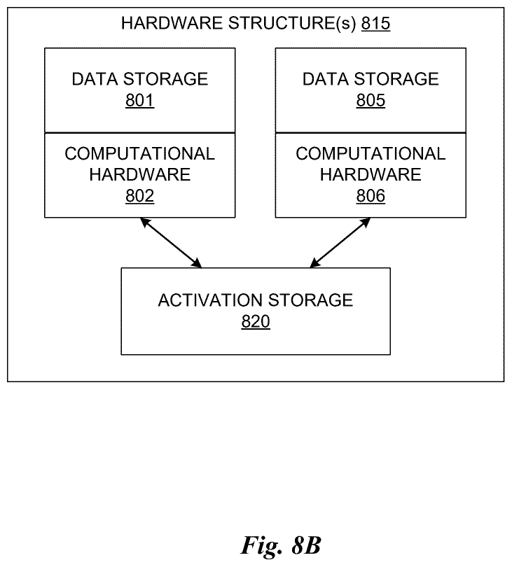

As noted above, a deep learning or neural learning system needs to be trained to generate inferences from input data. Details regarding inference and/or training logic 815 for a deep learning or neural learning system are provided below in conjunction with FIGS. 8A and/or 8B.

In at least one embodiment, inference and/or training logic 815 may include, without limitation, a data storage 801 to store forward and/or output weight and/or input/output data corresponding to neurons or layers of a neural network trained and/or used for inferencing in aspects of one or more embodiments. In at least one embodiment data storage 801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 801 may be included with other on-chip or off-chip data storage, including a processor's L1, L2, or L3 cache or system memory.

In at least one embodiment, any portion of data storage 801 may be internal or external to one or more processors or other hardware logic devices or circuits. In at least one embodiment, data storage 801 may be cache memory, dynamic randomly addressable memory (“DRAM”), static randomly addressable memory (“SRAM”), non-volatile memory (e.g., Flash memory), or other storage. In at least one embodiment, choice of whether data storage 801 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 815 may include, without limitation, a data storage 805 to store backward and/or output weight and/or input/output data corresponding to neurons or layers of a neural network trained and/or used for inferencing in aspects of one or more embodiments. In at least one embodiment, data storage 805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 805 may be included with other on-chip or off-chip data storage, including a processor's L1, L2, or L3 cache or system memory. In at least one embodiment, any portion of data storage 805 may be internal or external to on one or more processors or other hardware logic devices or circuits. In at least one embodiment, data storage 805 may be cache memory, DRAM, SRAM, non-volatile memory (e.g., Flash memory), or other storage. In at least one embodiment, choice of whether data storage 805 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 801 and data storage 805 may be separate storage structures. In at least one embodiment, data storage 801 and data storage 805 may be same storage structure. In at least one embodiment, data storage 801 and data storage 805 may be partially same storage structure and partially separate storage structures. In at least one embodiment, any portion of data storage 801 and data storage 805 may be included with other on-chip or off-chip data storage, including a processor's L1, L2, or L3 cache or system memory.

In at least one embodiment, inference and/or training logic 815 may include, without limitation, one or more arithmetic logic unit(s) (“ALU(s)”) 810 to perform logical and/or mathematical operations based, at least in part on, or indicated by, training and/or inference code, result of which may result in activations (e.g., output values from layers or neurons within a neural network) stored in an activation storage 820 that are functions of input/output and/or weight parameter data stored in data storage 801 and/or data storage 805. In at least one embodiment, activations stored in activation storage 820 are generated according to linear algebraic and or matrix-based mathematics performed by ALU(s) 810 in response to performing instructions or other code, wherein weight values stored in data storage 805 and/or data 801 are used as operands along with other values, such as bias values, gradient information, momentum values, or other parameters or hyperparameters, any or all of which may be stored in data storage 805 or data storage 801 or another storage on or off-chip. In at least one embodiment, ALU(s) 810 are included within one or more processors or other hardware logic devices or circuits, whereas in another embodiment, ALU(s) 810 may be external to a processor or other hardware logic device or circuit that uses them (e.g., a co-processor). In at least one embodiment, ALUs 810 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 801, data storage 805, and activation storage 820 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 820 may be cache memory, DRAM, SRAM, non-volatile memory (e.g., Flash memory), or other storage. In at least one embodiment, activation storage 820 may be completely or partially within or external to one or more processors or other logical circuits. In at least one embodiment, choice of whether activation storage 820 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 815 illustrated in FIG. 8A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8A may be used in conjunction with central processing unit (“CPU”) hardware, graphics processing unit (“GPU”) hardware or other hardware, such as field programmable gate arrays (“FPGAs”).

FIG. 8B illustrates inference and/or training logic 815, according to at least one embodiment. In at least one embodiment, inference and/or training logic 815 may include, without limitation, hardware logic in which computational resources are dedicated or otherwise exclusively used in conjunction with weight values or other information corresponding to one or more layers of neurons within a neural network. In at least one embodiment, inference and/or training logic 815 illustrated in FIG. 8B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8B may be used in conjunction with central processing unit (CPU) hardware, graphics processing unit (GPU) hardware or other hardware, such as field programmable gate arrays (FPGAs). In at least one embodiment, inference and/or training logic 815 includes, without limitation, data storage 801 and data storage 805, which may be used to store weight values and/or other information, including bias values, gradient information, momentum values, and/or other parameter or hyperparameter information. In at least one embodiment illustrated in FIG. 8B, each of data storage 801 and data storage 805 is associated with a dedicated computational resource, such as computational hardware 802 and computational hardware 806, respectively. In at least one embodiment, each of computational hardware 806 comprises one or more ALUs that perform mathematical functions, such as linear algebraic functions, only on information stored in data storage 801 and data storage 805, respectively, result of which is stored in activation storage 820.

In at least one embodiment, each of data storage 801 and 805 and corresponding computational hardware 802 and 806, respectively, correspond to different layers of a neural network, such that resulting activation from one “storage/computational pair 801/802” of data storage 801 and computational hardware 802 is provided as an input to next “storage/computational pair 805/806” of data storage 805 and computational hardware 806, in order to mirror conceptual organization of a neural network. In at least one embodiment, each of storage/computational pairs 801/802 and 805/806 may correspond to more than one neural network layer. In at least one embodiment, additional storage/computation pairs (not shown) subsequent to or in parallel with storage computation pairs 801/802 and 805/806 may be included in inference and/or training logic 815.

### Neural Network Training and Deployment

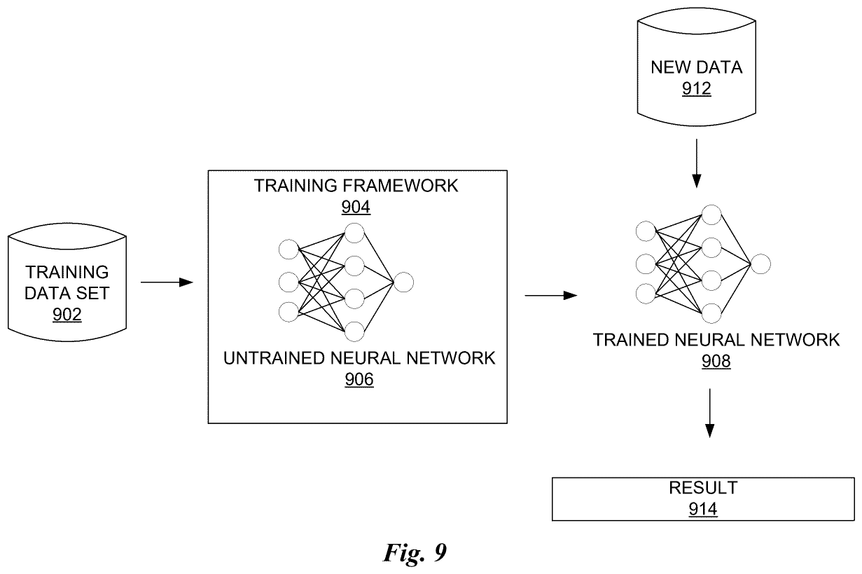

FIG. 9 illustrates another embodiment for training and deployment of a deep neural network. In at least one embodiment, untrained neural network 906 is trained using a training dataset 902. In at least one embodiment, training framework 904 is a PyTorch framework, whereas in other embodiments, training framework 904 is a Tensorflow, Boost, Caffe, Microsoft Cognitive Toolkit/CNTK, MXNet, Chainer, Keras, Deeplearning4j, or other training framework. In at least one embodiment training framework 904 trains an untrained neural network 906 and enables it to be trained using processing resources described herein to generate a trained neural network 908. In at least one embodiment, weights may be chosen randomly or by pre-training using a deep belief network. In at least one embodiment, training may be performed in either a supervised, partially supervised, or unsupervised manner.

In at least one embodiment, untrained neural network 906 is trained using supervised learning, wherein training dataset 902 includes an input paired with a desired output for an input, or where training dataset 902 includes input having known output and the output of the neural network is manually graded. In at least one embodiment, untrained neural network 906 is trained in a supervised manner processes inputs from training dataset 902 and compares resulting outputs against a set of expected or desired outputs. In at least one embodiment, errors are then propagated back through untrained neural network 906. In at least one embodiment, training framework 904 adjusts weights that control untrained neural network 906. In at least one embodiment, training framework 904 includes tools to monitor how well untrained neural network 906 is converging towards a model, such as trained neural network 908, suitable to generating correct answers, such as in result 914, based on known input data, such as new data 912. In at least one embodiment, training framework 904 trains untrained neural network 906 repeatedly while adjust weights to refine an output of untrained neural network 906 using a loss function and adjustment algorithm, such as stochastic gradient descent. In at least one embodiment, training framework 904 trains untrained neural network 906 until untrained neural network 906 achieves a desired accuracy. In at least one embodiment, trained neural network 908 can then be deployed to implement any number of machine learning operations.

In at least one embodiment, untrained neural network 906 is trained using unsupervised learning, wherein untrained neural network 906 attempts to train itself using unlabeled data. In at least one embodiment, unsupervised learning training dataset 902 will include input data without any associated output data or “ground truth” data. In at least one embodiment, untrained neural network 906 can learn groupings within training dataset 902 and can determine how individual inputs are related to untrained dataset 902. In at least one embodiment, unsupervised training can be used to generate a self-organizing map, which is a type of trained neural network 908 capable of performing operations useful in reducing dimensionality of new data 912. In at least one embodiment, unsupervised training can also be used to perform anomaly detection, which allows identification of data points in a new dataset 912 that deviate from normal patterns of new dataset 912.

In at least one embodiment, semi-supervised learning may be used, which is a technique in which in training dataset 902 includes a mix of labeled and unlabeled data. In at least one embodiment, training framework 904 may be used to perform incremental learning, such as through transferred learning techniques. In at least one embodiment, incremental learning enables trained neural network 908 to adapt to new data 912 without forgetting knowledge instilled within network during initial training.

### Data Center

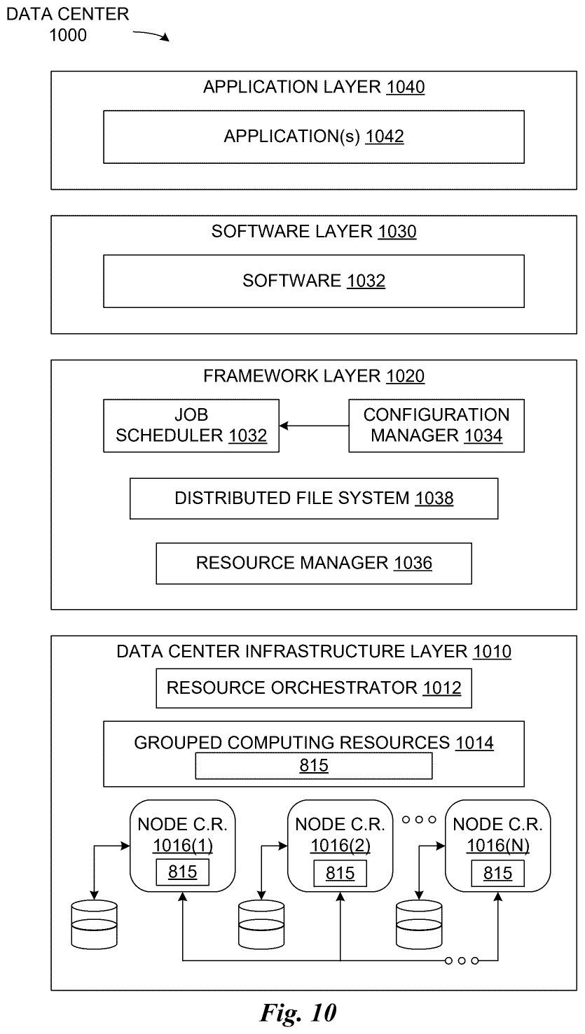

FIG. 10 illustrates an example data center 1000, in which at least one embodiment may be used. In at least one embodiment, data center 1000 includes a data center infrastructure layer 1010, a framework layer 1020, a software layer 1030 and an application layer 1040.

In at least one embodiment, as shown in FIG. 10, data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 1016(1)-1016(N) may be a server having one or more of above-mentioned computing resources.

In at least one embodiment, grouped computing resources 1014 may include separate groupings of node C.R.s housed within one or more racks (not shown), or many racks housed in data centers at various geographical locations (also not shown). Separate groupings of node C.R.s within grouped computing resources 1014 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 1022 may configure or otherwise control one or more node C.R.s 1016(1)-1016(N) and/or grouped computing resources 1014. In at least one embodiment, resource orchestrator 1022 may include a software design infrastructure (“SDI”) management entity for data center 1000. In at least one embodiment, resource orchestrator may include hardware, software or some combination thereof.

In at least one embodiment, as shown in FIG. 10, framework layer 1020 includes a job scheduler 1032, a configuration manager 1034, a resource manager 1036 and a distributed file system 1038. In at least one embodiment, framework layer 1020 may include a framework to support software 1032 of software layer 1030 and/or one or more application(s) 1042 of application layer 1040. In at least one embodiment, software 1032 or application(s) 1042 may respectively include web-based service software or applications, such as those provided by Amazon Web Services, Google Cloud and Microsoft Azure. In at least one embodiment, framework layer 1020 may be, but is not limited to, a type of free and open-source software web application framework such as Apache Spark™ (hereinafter “Spark”) that may utilize distributed file system 1038 for large-scale data processing (e.g., “big data”). In at least one embodiment, job scheduler 1032 may include a Spark driver to facilitate scheduling of workloads supported by various layers of data center 1000. In at least one embodiment, configuration manager 1034 may be capable of configuring different layers such as software layer 1030 and framework layer 1020 including Spark and distributed file system 1038 for supporting large-scale data processing. In at least one embodiment, resource manager 1036 may be capable of managing clustered or grouped computing resources mapped to or allocated for support of distributed file system 1038 and job scheduler 1032. In at least one embodiment, clustered or grouped computing resources may include grouped computing resource 1014 at data center infrastructure layer 1010. In at least one embodiment, resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. one or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. In at least one embodiment, self-modifying actions may relieve a data center operator of data center 1000 from making possibly bad configuration decisions and possibly avoiding underutilized and/or poor performing portions of a data center.

In at least one embodiment, data center 1000 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 1000. In at least one embodiment, trained machine learning models corresponding to one or more neural networks may be used to infer or predict information using resources described above with respect to data center 1000 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 815 are used to perform inferencing and/or training operations associated with one or more embodiments. In at least one embodiment, inference and/or training logic 815 may be used in system FIG. 10 for inferencing or predicting operations based, at least in part, on weight parameters calculated using neural network training operations, neural network functions and/or architectures, or neural network use cases described herein.

As described herein, a method, computer readable medium, and system are disclosed to provide for compression of a triplane representation of data. In accordance with FIGS. 1-7, embodiments may rely on a model usable for triplane compression. The model may be stored (partially or wholly) in one or both of data storage 801 and 805 in inference and/or training logic 815 as depicted in FIGS. 8A and 8B. Training and deployment of the model may be performed as depicted in FIG. 9 and described herein. Distribution of the model may be performed using one or more servers in a data center 1000 as depicted in FIG. 10 and described herein.

What is claimed is:

1. A method, comprising:
at a device:
processing a two-dimensional (2D) image of a face of a user captured using a first instance of a video conferencing application executing on a first user device, to generate a triplane representation of the face of the user;
compressing the triplane representation of the face of the user to form a compressed representation of the face of the user, using a codebook that stores a plurality of triplane features with corresponding codes;
transmitting the compressed representation of the face of the user over a network to a second user device executing a second instance of the video conferencing application,
wherein transmitting the compressed representation of the face of the user to the second user device causes the second user device to:
receive the compressed representation of the face of the user,
decompress the compressed representation of the face of the user to generate a reconstructed triplane representation of the face of the user,
render from the reconstructed triplane representation at least one view of the face of the user, and
display, on a display device of the second user device, the at least one view of the face of the user in an interface of the second instance of the video conferencing application.

2. The method of claim 1, wherein the triplane representation of the face of the user is generated using a generative triplane model.

3. The method of claim 1, wherein the codebook is a model of triplane features learned via machine learning.

4. The method of claim 1, wherein the corresponding codes are indices in the codebook.

5. The method of claim 1, wherein compressing the triplane representation of the face of the user to form the compressed representation of the face of the user, using the codebook includes:
processing the triplane representation of the face of the user, by an encoder, to infer a subset of codes in the codebook that correspond to triplane features representing the triplane representation of the face of the user, and
outputting the subset of codes as the compressed representation of the face of the user.

6. A method, comprising:
at a device:
compressing a triplane representation of data to form a compressed representation of the data, using a codebook that stores a plurality of triplane features with corresponding codes; and
outputting the compressed representation of the data.

7. The method of claim 6, wherein the data is a two-dimensional (2D) image.

8. The method of claim 7, wherein the 2D image is captured by a camera.

9. The method of claim 6, wherein the method further comprises, at the device:
generating the triplane representation of the data using a generative triplane model.

10. The method of claim 6, wherein the codebook is a model of triplane features learned via machine learning.

11. The method of claim 10, wherein the codebook is learned over a plurality of training iterations using a set of training data, including for each of the training iterations:
selecting an instance of data from the set of training data,
generating a triplane representation of the instance of data,
compressing the triplane representation of the instance of data to form a compressed representation of the instance of data, using a current instance of the codebook,
decompressing the compressed representation of the instance of data to form a reconstructed triplane representation of the instance of data, using the current instance of the codebook,
computing at least one loss using the reconstructed triplane representation of the instance of data, and
optimizing the current instance of the codebook based on the at least one loss to form a new current instance of the codebook.

12. The method of claim 11, wherein the at least one loss includes a reconstruction loss computed between the triplane representation of the instance of data and the reconstructed triplane representation of the instance of data, and wherein the current instance of the codebook is optimized to minimize the reconstruction loss.

13. The method of claim 11, wherein the at least one loss includes a perceptual loss computed between the instance of data selected from the set of training data and a reconstructed version of the instance of data generated from the reconstructed triplane representation of the instance of data, and wherein the current instance of the codebook is optimized to minimize the perceptual loss.

14. The method of claim 11, wherein the instance of data is an image of a face, and wherein the at least one loss includes an identity loss computed between identity features generated from the instance of data and reconstructed identity features generated from a reconstructed version of the instance of data which has been generated from the reconstructed triplane representation of the instance of data, and wherein the current instance of the codebook is optimized to minimize the identity loss.

15. The method of claim 11, wherein the selected instance of data is an instance of multi-view data, and wherein the at least one loss includes an adversarial loss between the triplane representation of the multi-view instance of data and the reconstructed triplane representation of the multi-view instance of data and between the instance of multi-view data and a reconstructed version of the multi-view instance of data generated from the reconstructed triplane representation of the multi-view instance of data, and wherein the current instance of the codebook is optimized to minimize the adversarial loss.

16. The method of claim 6, wherein the corresponding codes are indices in the codebook.

17. The method of claim 6, wherein compressing the triplane representation of the data to form the compressed representation of the data, using the codebook includes:
processing the triplane representation of the data, by an encoder, to infer a subset of codes in the codebook that correspond to triplane features representing the triplane representation of the data, and
outputting the subset of codes as the compressed representation of the data.

18. The method of claim 6, wherein the codebook is selected from among a plurality of codebooks for compressing the triplane representation of the data.

19. The method of claim 18, wherein the plurality of codebooks correspond to different compression ratios, and wherein the selected codebook corresponds to a compression ratio predetermined to be used for compressing the triplane representation of the data.

20. The method of claim 19, wherein the compression ratio is predetermined based on a current bandwidth available for transmitting the compressed representation of the data.

21. The method of claim 6, wherein outputting the compressed representation of the data includes storing the compressed representation of the data in a memory.

22. The method of claim 6, wherein outputting the compressed representation of the data includes providing the compressed representation of the data to a downstream task.

23. The method of claim 22, wherein the downstream task uses the compressed representation of the data to train a three-dimensional (3D) generative model.

24. The method of claim 6, wherein outputting the compressed representation of the data includes transmitting the compressed representation of the data over a network to a target device.

25. The method of claim 24, wherein the target device includes a decoder for decompressing the compressed representation of the data into a reconstructed triplane representation of the data, and wherein the target device is configured to render the data from the reconstructed triplane representation.

26. The method of claim 25, wherein the data is rendered for use with a video conferencing application.

27. The method of claim 25, wherein the data is rendered for use with an application depicting static 3D scenes.

28. The method of claim 25, wherein the data is rendered for use with an application depicting 3D scenes in video.

29. The method of claim 25, wherein the target device is configured to render a novel view from the reconstructed triplane representation.

30. A system, comprising:
a non-transitory memory storage comprising instructions; and
one or more processors in communication with the memory, wherein the one or more processors execute the instructions to:
compress a triplane representation of data to form a compressed representation of the data, using a codebook that stores a plurality of triplane features with corresponding codes; and
output the compressed representation of the data.

31. The system of claim 30, wherein the codebook is a model of triplane features learned via machine learning.

32. A non-transitory computer-readable media storing computer instructions which when executed by one or more processors of a device cause the device to:
compress a triplane representation of data to form a compressed representation of the data, using a codebook that stores a plurality of triplane features with corresponding codes; and
output the compressed representation of the data.

33. The non-transitory computer-readable media of claim 32, wherein the codebook is a model of triplane features learned via machine learning.
